(19) United States
(12) Patent Application Publication
(10) Pub. No.: US 2022/0021032 A1
(43) Pub. Date: Jan. 20, 2022

(54) NONAQUEOUS ELECTROLYTE SECONDARY BATTERY LAMINATED BODY

(71) Applicant: Sumitomo Chemical Company, Limited, Tokyo (JP)

(72) Inventors: Hideto NAKAJIMA, Niihama-shi (JP); Riku MATSUMINE, Niihama-shi (JP)

(21) Appl. No.: 17/376,971

(22) Filed: Jul. 15, 2021

(30) Foreign Application Priority Data
Jul. 17, 2020 (JP) 2020-123263

(51) Int. Cl. H01M 10/0569; H01M 50/417; H01M 50/423; H01M 4/505; H01M 4/525

(52) U.S. Cl. CPC H01M 10/0569; H01M 50/417; H01M 2300/0028; H01M 4/505; H01M 4/525; H01M 50/423

(57) ABSTRACT

A nonaqueous electrolyte secondary battery laminated body is provided in which a porous layer is less likely to be broken even when an external force is applied when the nonaqueous electrolyte secondary battery laminated body is present in a battery. The nonaqueous electrolyte secondary battery laminated body is such that a peel strength between a first electrode plate and an outermost surface layer of a nonaqueous electrolyte secondary battery laminated separator is lower than a peel strength between a porous layer and a polyolefin porous film when the nonaqueous electrolyte secondary battery laminated body has been subjected to Peeling Test A. Step 1A: A nonaqueous electrolyte secondary battery laminated body is immersed in a predetermined solvent. Step 2A: The first electrode plate is fixed on a substrate. Step 3A: The nonaqueous electrolyte secondary battery laminated separator is peeled off under a predetermined condition.

This Nonprovisional application claims priority under 35 U.S.C. § 119 on Patent Application No. 2020-123263 filed in Japan on Jul. 17, 2020, the entire contents of which are hereby incorporated by reference.

### TECHNICAL FIELD

The present invention relates to a laminated body for a nonaqueous electrolyte secondary battery (hereinafter referred to as a “nonaqueous electrolyte secondary battery laminated body”). The present invention also relates to a member for a nonaqueous electrolyte secondary battery (hereinafter referred to as a “nonaqueous electrolyte secondary battery member”), a nonaqueous electrolyte secondary battery, and a laminated separator for a nonaqueous electrolyte secondary battery (hereinafter referred to as a “nonaqueous electrolyte secondary battery laminated separator”).

### BACKGROUND ART

Nonaqueous electrolyte secondary batteries, in particular, lithium ion secondary batteries have a high energy density, and are thus in wide use as batteries for a personal computer, a mobile telephone, a portable information terminal, and the like. Such nonaqueous electrolyte secondary batteries have recently been developed as on-vehicle batteries.

A power-generating element included in a nonaqueous electrolyte secondary battery has a structure in which an electrode plate and a separator are laminated alternately. The technique of firmly adhering the electrode plate and the separator so that such a laminated structure can be maintained even when an external force is applied has been developed in terms of stability and safety (see, for example, Patent Literature 1).

### CITATION LIST

### Patent Literature

### [Patent Literature 1]

Japanese Patent Application Publication Tokukai No. 2014-149936

### SUMMARY OF INVENTION

### Technical Problem

A laminated separator in which a porous layer is formed on a polyolefin porous film is widely used as a nonaqueous electrolyte secondary battery separator. However, as a result of the study by the inventors of the present invention, it has been found that, when a nonaqueous electrolyte secondary battery laminated separator is used as a nonaqueous electrolyte secondary battery separator, a higher degree of adhesiveness between the electrode plate and the separator is not necessarily preferable. This because, when an external force is applied to the electrode plate-separator laminated body in the nonaqueous electrolyte secondary battery, an excessively high adhesiveness between the electrode plate and the separator may cause the porous layer to be peeled off from the polyolefin porous film while the porous layer remains adhered to the electrode plate. The occurrence of this peeling inside the battery causes a portion with a low heat resistance and a low strength. This can be a safety problem of the battery.

From the above consideration, the inventors of the present invention have first found that there is a technical demand for a nonaqueous electrolyte secondary battery laminated body in which adhesiveness between an electrode plate and a separator inside a battery is moderate, and a porous layer is less likely to be broken by application of an external force. It is an object of an aspect of the present invention to provide a nonaqueous electrolyte secondary battery laminated body in which a porous layer is less likely to be broken even when an external force is applied in a state in which the nonaqueous electrolyte secondary battery laminated body is present in a battery.

### Solution to Problem

The present invention encompasses the following features.

<1>

A nonaqueous electrolyte secondary battery laminated body in which a first electrode plate and a nonaqueous electrolyte secondary battery laminated separator are laminated,

the nonaqueous electrolyte secondary battery laminated separator including: a polyolefin porous film; and a porous layer which is formed on one surface or both surfaces of the polyolefin porous film,

wherein the nonaqueous electrolyte secondary battery laminated separator has an outermost surface layer which is in contact with the first electrode plate and which has adhesiveness with respect to the first electrode plate,

a peel strength between the first electrode plate and the outermost surface layer of the nonaqueous electrolyte secondary battery laminated separator is lower than a peel strength between the porous layer and the polyolefin porous film, when said nonaqueous electrolyte secondary battery laminated body has been subjected to Peeling Test A under the following conditions:

Step 1A. Said nonaqueous electrolyte secondary battery laminated body is immersed, at 60° C. for 24 hours, in a solvent of ethylene carbonate, dimethyl carbonate, ethyl methyl carbonate in a volume ratio of 30:35:35;

Step 2A. The first electrode plate is fixed on a substrate; and

Step 3A. The nonaqueous electrolyte secondary battery laminated separator is peeled off at a peeling speed of 100 mm/min so that an angle between the first electrode plate and the nonaqueous electrolyte secondary battery laminated separator is 180°.

<2>

The nonaqueous electrolyte secondary battery laminated body described in <1>, wherein the peel strength in the Step 3A is not more than 8 N/m.

<3>

The nonaqueous electrolyte secondary battery laminated body described in <1> or <2>, wherein the peel strength between the first electrode plate and the outermost surface layer of the nonaqueous electrolyte secondary battery laminated separator is lower than the peel strength between the porous layer and the polyolefin porous film, when said nonaqueous electrolyte secondary battery laminated body has been subjected to Peeling Test B under the following conditions:

Step 1B. The nonaqueous electrolyte secondary battery laminated body is dried so that a content of the solvent is not more than 2% by weight;

Step 2B. The first electrode plate is fixed on the substrate; and

Step 3B. The nonaqueous electrolyte secondary battery laminated separator is peeled off at a peeling speed of 100 mm/min so that an angle between the first electrode plate and the nonaqueous electrolyte secondary battery laminated separator is 180°.

<4>

The nonaqueous electrolyte secondary battery laminated body described in <3>, wherein the first electrode plate is a positive electrode plate, and

the peel strength in the Step 3B is not more than 8 N/m.

<5>

The nonaqueous electrolyte secondary battery laminated body described in any of <1> to <4>, wherein the porous layer contains one or more resins selected from the group consisting of (meth)acrylate-based resins, fluorine-containing resins, polyamide-based resins, polyimide-based resins, polyamideimide-based resins, polyester-based resins, and water-soluble polymers.

<6>

The nonaqueous electrolyte secondary battery laminated body described in any of <1> to <5>, wherein the porous layer contains an aramid resin.

<7>

A nonaqueous electrolyte secondary battery member including: a nonaqueous electrolyte secondary battery laminated body described in any of <1> to <6>; and a second electrode plate,

wherein, in said nonaqueous electrolyte secondary battery member, the first electrode plate, the nonaqueous electrolyte secondary battery laminated separator, and the second electrode plate are disposed in this order.

<8>

The nonaqueous electrolyte secondary battery member described in <7>, wherein one of the first electrode plate and the second electrode plate is a positive electrode plate, and the other is a negative electrode plate,

the peel strength between the positive electrode plate and the nonaqueous electrolyte secondary battery laminated separator is lower than the peel strength between the negative electrode plate and the nonaqueous electrolyte secondary battery laminated separator.

<9>

A nonaqueous electrolyte secondary battery including: a nonaqueous electrolyte secondary battery laminated body described in any of <1> to <6>; or a nonaqueous electrolyte secondary battery member described in <7> or <8>.

<10>

A nonaqueous electrolyte secondary battery laminated separator including: a polyolefin porous film; and a porous layer which is formed one surface or both surfaces of the polyolefin porous film,

wherein at least one of outermost surface layers of the nonaqueous electrolyte secondary battery laminated separator lies on a side of the porous layer and has adhesiveness with respect to a test electrode plate,

the test electrode plate is a 1-mm-thick laminated body in which an electrode active material consisting of lithium nickel cobalt manganese oxide (NCM523), carbon black, graphite, and PVDF in a ratio of 92:2.5:2.5:3 is formed on an aluminum foil,

a peel strength between the test electrode plate and the outermost surface layer of the nonaqueous electrolyte secondary battery laminated separator is lower than a peel strength between the porous layer and the polyolefin porous film, when said nonaqueous electrolyte secondary battery laminated body has been subjected to Peeling Test C under the following conditions:

Step 1C. The nonaqueous electrolyte secondary battery laminated separator and the test electrode plate are laminated such that the porous layer and the test electrode plate face each other via the outermost surface layer having adhesiveness with respect to the test electrode plate, and pressing is performed under the conditions of 70° C., 6 MPa, and 10 seconds to prepare a test laminated body;

Step 2C. The test laminated body is immersed, at 60° C. for 24 hours, in a solvent of ethylene carbonate, dimethyl carbonate, ethyl methyl carbonate in a volume ratio of 30:35:35;

Step 3C. The test electrode plate is fixed on a substrate; and

Step 4C. The nonaqueous electrolyte secondary battery laminated separator is peeled off at a peeling speed of 100 mm/min so that an angle between the test electrode plate and the nonaqueous electrolyte secondary battery laminated separator is 180°.

### Advantageous Effects of Invention

According to an aspect of the present invention, it is possible to provide a nonaqueous electrolyte secondary battery laminated body in which a porous layer is less likely to be broken even when an external force is applied in a state in which the nonaqueous electrolyte secondary battery laminated body is present in a battery.

### BRIEF DESCRIPTION OF DRAWINGS

FIG. 1 is a diagram schematically illustrating a nonaqueous electrolyte secondary battery laminated body in accordance with an aspect of the present invention.

FIG. 2 is a diagram schematically illustrating a nonaqueous electrolyte secondary battery laminated body in accordance with another aspect of the present invention.

FIG. 3 is a view schematically illustrating a peeling test in the present invention.

FIG. 4 is a diagram schematically illustrating a nonaqueous electrolyte secondary battery member in accordance with an aspect of the present invention.

### DESCRIPTION OF EMBODIMENTS

The following description will discuss embodiments of the present invention. The present invention is, however, not limited to the embodiments below. The present invention is not limited to the arrangements described below, but may be altered in various ways by a skilled person within the scope of the claims. Any embodiment based on a proper combination of technical means disclosed in different embodiments is also encompassed in the technical scope of the present invention. Note that numerical expressions such as “A to B” herein mean “not less than A and not more than B” unless otherwise stated.

[1. Nonaqueous Electrolyte Secondary Battery Laminated Body]

As described earlier, in the power-generating element included in the nonaqueous electrolyte secondary battery, the electrode plate and the separator which are laminated are usually adhered to prevent the electrode plate and the separator from being displaced from each other. Conventionally, it has been considered that firmer adhesion between the electrode plate and the separator is preferable.

However, as a result of the study by the inventors of the present invention, it has been found that, when a nonaqueous electrolyte secondary battery laminated separator is used as a separator, a problem occurs if the degree of adhesion between the electrode plate and the separator causes a problem is excessively high. That is, when an external force is applied to the electrode plate-separator laminated body in the nonaqueous electrolyte secondary battery, the porous layer may be peeled off from the polyolefin porous film while the porous layer remains adhered to the electrode plate. Therefore, in the state of being immersed in the electrolyte, it is preferable that the “peel strength between the electrode plate and the nonaqueous electrolyte secondary battery laminated separator” is lower than the “peel strength between the polyolefin porous film and the porous layer”. If such a magnitude relationship of the peel strength is established, peeling between the electrode plate and the porous layer occurs first when an external force is applied to the electrode plate-separator laminate in the nonaqueous electrolyte secondary battery. This makes it possible to prevent the porous layer from peeling from the polyolefin porous film.

In a preferable embodiment, even in a dry state in which almost no electrolyte is contained, the “peel strength between the electrode plate and the nonaqueous electrolyte secondary battery laminated separator” is lower than the “peel strength between the polyolefin porous film and the porous layer”. If such a magnitude relationship of the peel strength is established, peeling between the electrode plate and the porous layer occurs first when an external force is applied to the electrode plate-separator laminated body in a dry state (for example, during production or transportation of the electrode plate-separator laminated body). This makes it possible to prevent the porous layer from being peeling from the polyolefin porous film.

In an aspect of the present invention, the nonaqueous electrolyte secondary battery laminated body having the relationship of the peel strength described above is specified by the results of Peeling Test A and Peeling Test B. The Peeling Test A is a test for determining the magnitude relationship of the peel strength between individual layers in a nonaqueous electrolyte secondary battery laminated body in a state of being immersed in an electrolyte. The Peeling Test B is a test for determining the magnitude relationship of the peel strength between individual layers in a nonaqueous electrolyte secondary battery laminated body in a dry state.

Further, in an aspect of the present invention, a nonaqueous electrolyte secondary battery laminated separator specified by a result of Peeling Test C is also provided. The Peeling Test C is a test in which the Peeling Test A is modified so that it can be applied to a nonaqueous electrolyte secondary battery laminated separator.

The adhesiveness between the electrode plate and the nonaqueous electrolyte secondary battery laminated separator can be adjusted according to, for example, a content of an adhesive resin in the porous layer or in an adhesion layer, a weight per unit area of the porous layer or the adhesion layer, and press conditions at the production of the electrode-separator laminated body. In general, when the content of the adhesive resin is higher, firmer adhesion tends to be made. Further, when the weight per unit area of the porous layer or the adhesion layer is higher, firmer adhesion tends to be made. Moreover, when pressing is performed for a longer pressing time, at a higher pressing temperature, under higher pressure, firmer adhesion tends to be made.

[Structure of Nonaqueous Electrolyte Secondary Battery Laminated Body]

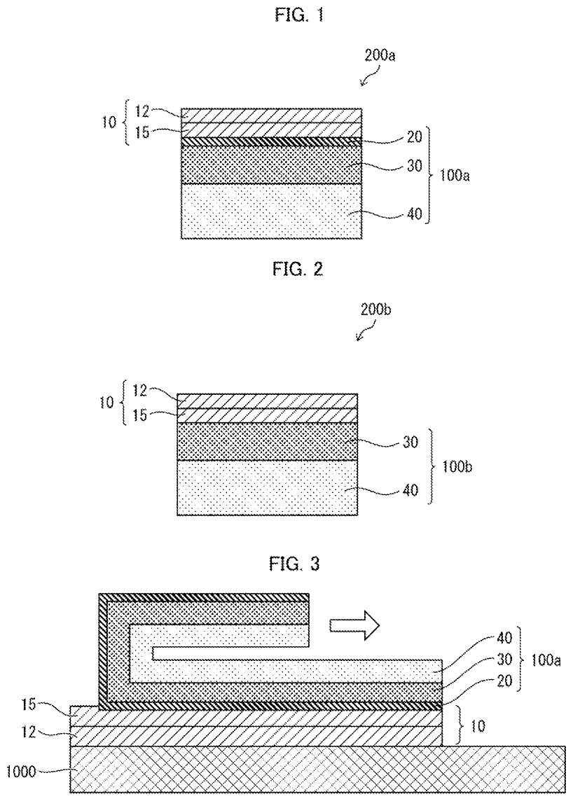

Reference will be made to FIGS. 1 and 2. A nonaqueous electrolyte secondary battery laminated body 200a (or 200b) in accordance with an aspect of the present invention is a laminate of a first electrode plate 10 and a nonaqueous electrolyte secondary battery laminated separator 100a (or 100b).

The first electrode plate 10 may be a positive electrode plate or may be a negative electrode plate. The first electrode plate 10 is a laminate of a current collector 12 and an electrode active material layer 15 (positive electrode active material layer or negative electrode active material layer). The first electrode plate 10 illustrated in FIGS. 1 and 2 is such that the electrode active material layer 15 is formed onto one side of the current collector 12, for use in a peeling test described later. However, the first electrode plate 10 may have a structure in which the electrode active material layer 15 is formed onto both surfaces of the current collector 12.

The nonaqueous electrolyte secondary battery laminated separator 100a (or 100b) is such that a porous layer 30 is formed on one surface or both surfaces of the polyolefin porous film 40. FIGS. 1 and 2 depict examples in which the porous layer 30 is formed on one surface of the polyolefin porous film 40.

In the nonaqueous electrolyte secondary battery laminated body 200a (or 200b), the first electrode plate 10 and the nonaqueous electrolyte secondary battery laminated separator 100a (or 100b) are laminated such that the electrode active material layer 15 and the porous layer 30 face each other. At this time, an outermost surface layer of the nonaqueous electrolyte secondary battery laminated separator 100a (or 100b) being in contact with the first electrode plate 10 is a layer having adhesiveness with respect to the first electrode plate 10. The layer having adhesiveness with respect to the first electrode plate 10 may be an adhesion layer 20 which is provided separately from the porous layer 30 (see FIG. 1). Alternatively, the layer having adhesiveness with respect to the first electrode plate 10 may be the porous layer 30 itself (see FIG. 2).

[Peeling Test A]

The Peeling Test A is a test for determining the magnitude relationship of the peel strength between individual layers in the nonaqueous electrolyte secondary battery laminated body 200a (or 200b) in a state of being immersed in an electrolyte. The Peeling Test A is carried out according to the following procedure.

(Step 1A) The nonaqueous electrolyte secondary battery laminated body 200a (or 200b) is immersed, at 60° C. for 24 hours, in a solvent of ethylene carbonate, dimethyl carbonate, ethyl methyl carbonate in a volume ratio of 30:35:35.
(Step 2A) The first electrode plate 10 is fixed on the substrate 1000.
(Step 3A) The nonaqueous electrolyte secondary battery laminated separator 100a (or 100b) is peeled off at a peeling speed of 100 mm/min so that the angle between the first electrode plate 10 and the nonaqueous electrolyte secondary battery laminated separator 100a (or 100b) is 180°.

In Step 1A, the nonaqueous electrolyte secondary battery laminated body 200a (or 200b) is immersed in the solvent having a predetermined composition. This reproduces the nonaqueous electrolyte secondary battery laminated body 200a (or 200b) in a state of being immersed in the electrolyte. Even though nonaqueous electrolyte secondary battery laminated bodies 200a (or 200b) have been immersed in different types of electrolytes (for example, when they are taken out of battery products), the immersion in the electrolyte of a specific composition in the Step 1A makes it possible to make uniform conditions of the nonaqueous electrolyte secondary battery laminated bodies 200a (or 200b) to be subjected to the Peeling Test A.

In Step 2A, the first electrode plate 10 is fixed on the substrate 1000 such that the current collector 12 faces the substrate 1000 (see FIG. 3). A material of the substrate 1000 and a method of fixing the first electrode plate 10 are not particularly limited as long as the first electrode plate 10 can be fixed to the extent that the first electrode plate 10 can withstand the peeling test. As an example, the substrate 1000 is a glass epoxy plate. As an example, the first electrode plate 10 is fixed on the substrate 1000 with a double-sided tape.

In Step 3A, an apparatus for peeling the nonaqueous electrolyte secondary battery laminated separator 100a (or 100b) is exemplified by a peeling test apparatus. A person skilled in the art could select an appropriate peeling test apparatus capable of achieving the above-mentioned peeling test conditions.

The nonaqueous electrolyte secondary battery laminated body 200a (or 200b), when having been subjected to the Peeling Test A, is such that the peel strength between the first electrode plate 10 and the outermost surface layer of the nonaqueous electrolyte secondary battery laminated separator 100a (or 100b) is lower than the peel strength between the porous layer 30 and the polyolefin porous film 40. Therefore, after Step 3A, the amount of the porous layer 30 sticking onto the electrode active material layer 15 is small if any. In an embodiment, the area of the porous layer 30 sticking onto the electrode active material layer 15 is preferably not more than 5%, more preferably not more than 1%, and even more preferably 0%, when the area of the porous layer 30 having been adhered to the electrode active material layer 15 before the Peeling Test A is 100%. In one embodiment, the first electrode plate 10 and the nonaqueous electrolyte secondary battery laminated separator 100a (or 100b) are peeled off at an interface between the electrode active material layer 15 and the porous layer 30.

The area of the porous layer 30 sticking onto the electrode active material layer 15 can be measured by, for example, by image analysis. Normally, the electrode active material layer 15 takes on a black tinge, and the porous layer 30 is close to white. Therefore, with use of appropriate image processing software (e.g., ImageJ), the electrode active material layer 15 and the porous layer 30 are distinguished by the difference in color tone, so that the area of the porous layer 30 can be measured.

After Step 3A, the adhesion layer 20 may be sticking onto the electrode active material layer 15 or on the porous layer 30. This is because the adhesion layer 20 is usually a fairly thin layer, and it is difficult to determine whether the adhesion layer 20 is sticking to the electrode active material layer 15 or the porous layer 30. In FIG. 3, the adhesion layer 20 is depicted even in the peeled portion of the nonaqueous electrolyte secondary battery laminated separator 100a. However, this is merely a depiction for the purpose of convenience.

After step 3A, the amount of the electrode active material layer 15 sticking onto the porous layer 30 is preferably zero, but a small amount is acceptable. In an embodiment, the area of the electrode active material layer 15 sticking onto the porous layer 30 is not more than 5%, when the area of the electrode active material layer 15 having been adhered to the porous layer 30 before the Peeling Test A is 100%.

In Step 3A, the peel strength when the nonaqueous electrolyte secondary battery laminated separator 100a (or 100b) is peeled off is not particularly limited. This is because in the present invention, it is important that the area of the porous layer 30 sticking to the electrode active material layer 15 after Step 3A is small (the area of the porous layer 30 peeled off from the polyolefin porous film 40 is small). In an embodiment, the peel strength is preferably not more than 8 N/m, more preferably not more than 7 N/m, and even more preferably not more than 6 N/m. A lower limit of the peel strength is preferably not less than 0.8 N/m, and more preferably not less than 1 N/m. When the peel strength falls within the above range, there is a tendency, in a state of being immersed in the electrolyte, that adhesiveness between the first electrode plate 10 and the nonaqueous electrolyte secondary battery laminated separator 100a (or 100b) is moderate, and the structure of the nonaqueous electrolyte secondary battery laminated body 200a (or 200b) can be maintained.

In Step 3A, the peel strength when the nonaqueous electrolyte secondary battery laminated separator 100a (or 100b) is peeled can be measured by an appropriate device. The device for measuring the peel strength may be integrated with a device for carrying out the peeling test.

[Peeling Test B]

The Peeling Test B is a test for determining the magnitude relationship of the peel strength between individual layers in the nonaqueous electrolyte secondary battery laminated body 200a (or 200b) in a dry state. The Peeling Test B is carried out according to the following procedure.

(Step 1B) The nonaqueous electrolyte secondary battery laminated body 200a (or 200b) is dried so that the solvent content is not more than 2% by weight.
(Step 2B) The first electrode plate 10 is fixed on the substrate 1000.
(Step 3B) The nonaqueous electrolyte secondary battery laminated separator 100a (or 100b) is peeled off at a peeling speed of 100 mm/min so that the angle between the first electrode plate 10 and the nonaqueous electrolyte secondary battery laminated separator 100a (or 100b) is 180°.

In Step 1B, a method of removing the solvent from the nonaqueous electrolyte secondary battery laminated body 200a (or 200b) is not particularly limited. For example, the solvent can be removed by washing the nonaqueous electrolyte secondary battery laminated body 200a (or 200b) taken out from the battery product with a volatile solvent and drying it under reduced pressure. Further, the nonaqueous electrolyte secondary battery laminated body 200a (or 200b) before being assembled into a battery may be used.

The nonaqueous electrolyte secondary battery laminated body 200a (or 200b), when having been subjected to the Peeling Test B, is such that the peel strength between the first electrode plate 10 and the outermost surface layer of the nonaqueous electrolyte secondary battery laminated separator 100a (or 100b) is lower than the peel strength between the porous layer 30 and the polyolefin porous film 40. Therefore, after Step 3B, the amount of the porous layer 30 sticking onto the electrode active material layer 15 is small if any. In an embodiment, the area of the porous layer 30 sticking onto the electrode active material layer 15 is preferably not more than 5%, more preferably not more than 1%, and even more preferably 0%, when the area of the porous layer 30 having been adhered to the electrode active material layer 15 before the Peeling Test B is 100%. In an embodiment, the first electrode plate 10 and the nonaqueous electrolyte secondary battery laminated separator 100a (or 100b) are peeled off at an interface between the electrode active material layer 15 and the porous layer 30.

In Step 3B, the peel strength when the nonaqueous electrolyte secondary battery laminated separator 100a (or 100b) is peeled off is not particularly limited. This is because in the present invention, it is important that the area of the porous layer 30 sticking to the electrode active material layer 15 after Step 3B is small (the area of the porous layer 30 peeled off from the polyolefin porous film 40 is small). In an embodiment, (i) the first electrode plate 10 is a positive electrode plate, and (ii) the peel strength in Step 3B is preferably not more than 8 N/m, and more preferably not more than 7.5 N/m. The lower limit of the peel strength is preferably not less than 0.8 N/m, more preferably not less than 1 N/m, even more preferably not less than 1.2 N/m, and still more preferably not less than 1.5 N/m. When the peel strength falls within the above range, there is a tendency, in a dry state, that adhesiveness between the positive electrode plate and the nonaqueous electrolyte secondary battery laminated separator 100a (or 100b) is moderate, and the structure of the nonaqueous electrolyte secondary battery laminated body 200a (or 200b) can be maintained.

For other conditions related to the Peeling Test B, the description about the Peeling Test A is incorporated. Therefore, a repeated description is omitted.

In FIG. 3 is depicted a state in which the nonaqueous electrolyte secondary battery laminated body 200a including the nonaqueous electrolyte secondary battery laminated separator 100a and the first electrode plate 10 is subjected to the Peeling Test A or the Peeling Test B. However, the nonaqueous electrolyte secondary battery laminated body 200b including the nonaqueous electrolyte secondary battery laminated separator 100b and the first electrode plate 10 can also be subjected to the Peeling Test A or the Peeling Test B. Further, the laminated body (i.e., a nonaqueous electrolyte secondary battery member 500) in which the second electrode plate is provided on the polyolefin porous film 40 can also be subjected to the Peeling Test A or the Peeling Test B.

[2. Nonaqueous Electrolyte Secondary Battery Member]

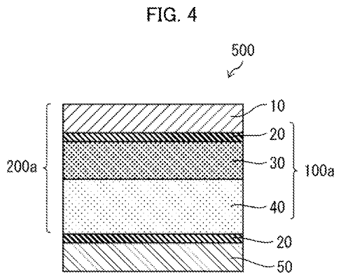

Reference will be made to FIG. 4. The nonaqueous electrolyte secondary battery member 500 in accordance with an aspect of the present invention includes: a nonaqueous electrolyte secondary battery laminated body 200a (or 200b) and a second electrode plate 50. In the nonaqueous electrolyte secondary battery member 500, the first electrode plate 10, the nonaqueous electrolyte secondary battery laminated separator 100a (or 100b), and the second electrode plate 50 are disposed in this order.

When the first electrode plate 10 is a positive electrode plate, the second electrode plate 50 is a negative electrode plate. When the first electrode plate 10 is a negative electrode plate, the second electrode plate 50 is a positive electrode plate.

When the porous layer 30 is formed on one surface of the polyolefin porous film 40, the porous layer 30 is disposed between the first electrode plate 10 and the polyolefin porous film 40. When the porous layer 30 is formed on both surfaces of the polyolefin porous film, the porous layer 30 is further disposed between the second electrode plate 50 and the polyolefin porous film 40.

The adhesion layer 20, which is provided as an optional member, can be disposed at one or more positions selected from the following positions: (i) a position between the first electrode plate 10 and the porous layer 30 provided on the first electrode plate 10 side, (ii) a position between the polyolefin porous film 40 and the second electrode plate 50, and (iii) a position between the porous layer 30 provided on the second electrode plate 50 side and the second electrode plate 50. In FIG. 4, the adhesion layer 20 is disposed at the positions (i) and (ii) among the above-described positions.

In an embodiment, the peel strength between the positive electrode plate and the nonaqueous electrolyte secondary battery laminated separator 100a (or 100b) is lower than the peel strength between the negative electrode plate and the nonaqueous electrolyte secondary battery laminated separator 100a (or 100b). That is, the negative electrode plate is more firmly adhered to the nonaqueous electrolyte secondary battery laminated separator 100a (or 100b) than the positive electrode plate is.

With such a configuration, when an external force is applied to the nonaqueous electrolyte secondary battery member 500 inside the battery, peeling between the positive electrode plate and the nonaqueous electrolyte secondary battery laminated separator 100a (or 100b) occurs first when an external force is applied to the nonaqueous electrolyte secondary battery member 500 inside the battery. This maintains adhesiveness between the negative electrode plate and the nonaqueous electrolyte secondary battery laminated separator 100a (or 100b). A gap between the negative electrode plate and the nonaqueous electrolyte secondary battery laminated separator 100a (or 100b) can become a cause of dendrite generation. Therefore, the above configuration is less likely to lead to the cause of dendrite generation even when an external force is applied to a battery, and thus improves the safety of the battery.

[3. Nonaqueous Electrolyte Secondary Battery Laminated Separator]

According to an aspect of the present invention, when Peeling Test C described later is performed, the nonaqueous electrolyte secondary battery laminated separator 100a (or 100b) is provided in which the magnitude of the peel strength between individual layers are in a predetermined relationship. The Peeling Test C includes a step of preparing the nonaqueous electrolyte secondary battery laminated body 200a (or 200b) with use of a predetermined electrode plate under a predetermined pressing condition. The Peeling Test C is a test in which the Peeling Test A is modified by making testing conditions uniform so that it can be applied to a nonaqueous electrolyte secondary battery laminated separator.

[Peeling Test C]

The Peeling Test C is a test for determining the magnitude relationship of the peel strength between the nonaqueous electrolyte secondary battery laminated separator 100a (or 100b) and a test laminated body including a test electrode plate, in a state of being immersed in an electrolyte. The Peeling Test C is carried out according to the following procedure.

(Step 1C) The nonaqueous electrolyte secondary battery laminated separator 100a (or 100b) and the test electrode plate are laminated via the outermost surface layer, of the nonaqueous electrolyte secondary battery laminated separator 100a (or 100b), having adhesiveness with respect to the test electrode plate. Next, the test laminated body is prepared by performing pressing under the conditions of 70° C., 6 MPa, and 10 seconds.
(Step 2C) The test laminated body is immersed, at 60° C. for hours, in a solvent of ethylene carbonate, dimethyl carbonate, ethyl methyl carbonate in a volume ratio of 30:35:35.
(Step 3C) The test electrode plate is fixed on the substrate 1000.
(Step 4C) The nonaqueous electrolyte secondary battery laminated separator 100a (or 100b) is peeled off at a peeling speed of 100 mm/min so that the angle between the test electrode plate and the nonaqueous electrolyte secondary battery laminated separator 100a (or 100b) is 180°.

At least one of outermost surface layers of the nonaqueous electrolyte secondary battery laminated separator 100a (or 100b) lies on the porous layer 30 side and has adhesiveness with respect to the test electrode plate. In Step 1C, the nonaqueous electrolyte secondary battery laminated separator 100a (or 100b) and the test electrode plate are adhered via this outermost surface layer. The outermost surface layer having adhesiveness with respect to the test electrode plate may be the adhesion layer 20 which is provided on the porous layer 30, as in the case of the nonaqueous electrolyte secondary battery laminated separator 100a. Alternatively, the outermost surface layer having adhesiveness with respect to the test electrode plate may be the porous layer 30 itself, as in the case of the nonaqueous electrolyte secondary battery laminated separator 100b.

The test electrode plate used in the Peeling Test C is a 1-mm-thick laminated body in which an electrode active material consisting of lithium nickel cobalt manganese oxide (NCM523), carbon black, graphite, and PVDF in a ratio of 92:2.5:2.5:3 is formed on an aluminum foil.

The test laminated body, when having been subjected to the Peeling Test C, is such that the peel strength between the test electrode plate and the outermost surface layer of the nonaqueous electrolyte secondary battery laminated separator 100a (or 100b) is lower than the peel strength between the porous layer 30 and the polyolefin porous film 40. Therefore, after Step 4A, the amount of the porous layer 30 sticking onto the test electrode plate is small if any. In an embodiment, the area of the porous layer 30 sticking onto the test electrode plate is preferably not more than 5%, more preferably not more than 1%, and even more preferably 0%, when the area of the porous layer 30 having been adhered to the test electrode plate before the Peeling Test C is 100%. In an embodiment, the first electrode plate 10 and the nonaqueous electrolyte secondary battery laminated separator 100a (or 100b) are peeled off at an interface between the electrode active material layer 15 and the porous layer 30.

In Step 4C, the peel strength when the nonaqueous electrolyte secondary battery laminated separator 100a (or 100b) is peeled off is not particularly limited. This is because in the present invention, it is important that the area of the porous layer 30 sticking to the test electrode plate after Step 4C is small (the area of the porous layer 30 peeled off from the polyolefin porous film 40 is small). In an embodiment, the peel strength is preferably not more than 8 N/m, more preferably not more than 7 N/m, and even more preferably not more than 6 N/m. A lower limit of the peel strength is preferably not less than 0.8 N/m, and more preferably not less than 1 N/m. When the peel strength falls within the above range, there is a tendency, in a state of being immersed in the electrolyte, that adhesiveness between the electrode plate and the nonaqueous electrolyte secondary battery laminated separator 100a (or 100b) is moderate, and the structure of the nonaqueous electrolyte secondary battery laminated body can be maintained.

For other conditions related to the Peeling Test C, the description about the Peeling Test A is incorporated. Therefore, a repeated description is omitted.

[4. Materials that Make Up Each Member]

This section will explain what kind of material(s) each of the members appearing in each of the above sections is made of.

[Nonaqueous Electrolyte Secondary Battery Laminated Separator]

The nonaqueous electrolyte secondary battery laminated separator 100a (or 100b) is such that the porous layer 30 is formed on one surface or both surfaces of the polyolefin porous film 40. FIGS. 1 to 5 depict the nonaqueous electrolyte secondary battery laminated separator 100a (or 100b) in which the porous layer 30 is formed on one surface of the polyolefin porous film 40.

The nonaqueous electrolyte secondary battery laminated separator 100a (or 100b) may have an outermost surface layer having adhesiveness to the electrode. As in the case of the nonaqueous electrolyte secondary battery laminated separator 100a, the adhesion layer 20 which differs from the porous layer 30 may be provided as the outermost surface layer having adhesiveness to the electrode. As in the case of the nonaqueous electrolyte secondary battery laminated separator 100b, the porous layer 30 itself may be caused to serve as the outermost surface layer having adhesiveness to the electrode. Alternatively, the outermost surface layer having adhesiveness to the electrode may be provided on both surfaces of the polyolefin porous film 40. In any of these cases, the outermost surface layer having adhesiveness to the electrode is provided on at least one of surfaces of the nonaqueous electrolyte secondary battery laminated separator 100a (or 100b) which surfaces contact the electrode plate (the positive electrode plate or the negative electrode plate).

(Polyolefin Porous Film)

A polyolefin porous film has therein many pores connected to one another, so that a gas and/or a liquid can pass through the polyolefin porous film from one side to the other side. The polyolefin porous film can serve as a base material for a nonaqueous electrolyte secondary battery laminated separator. When a battery including a nonaqueous electrolyte secondary battery laminated separator including a polyolefin porous film generates heat, the polyolefin porous film melts so as to make the nonaqueous electrolyte secondary battery laminated separator non-porous. Thus, the polyolefin porous film can impart a shutdown function to the nonaqueous electrolyte secondary battery laminated separator.

Note, here, that the “polyolefin porous film” is a porous film which contains a polyolefin-based resin as a main component. Note that the phrase “contains a polyolefin-based resin as a main component” means that a porous film contains a polyolefin-based resin at a proportion of not less than 50% by volume, preferably not less than 90% by volume, and more preferably not less than 95% by volume, relative to the whole of materials of which the porous film is made.

Examples of the polyolefin-based resin that the polyolefin porous film contains as a main component include, but are not particularly limited to, homopolymers and copolymers both of which are thermoplastic resins and are each produced through polymerization of a monomer(s) such as ethylene, propylene, 1-butene, 4-methyl-1-pentene, and/or 1-hexene. Specifically, examples of such homopolymers include polyethylene, polypropylene, and polybutene, and examples of such copolymers include an ethylene-propylene copolymer. The polyolefin porous film can include a layer containing only one of these polyolefin-based resins or a layer containing two or more of these polyolefin-based resins. Among these, polyethylene is more preferable as it is capable of preventing (shutting down) a flow of an excessively large electric current at a lower temperature. A high molecular weight polyethylene containing ethylene as a main component is particularly preferable. Note that the polyolefin porous film can contain a component(s) other than polyolefin as long as such a component does not impair the function of the layer.

Examples of the polyethylene encompass low-density polyethylene, high-density polyethylene, linear polyethylene (ethylene-α-olefin copolymer), and ultra-high molecular weight polyethylene. Among these polyethylenes, an ultra-high molecular weight polyethylene is more preferable, and an ultra-high molecular weight polyethylene containing a high molecular weight component having a weight-average molecular weight of 5×10⁵ to 15×10⁶ is even more preferable. In particular, the polyolefin-based resin more preferably contains a high molecular weight component having a weight-average molecular weight of not less than 1,000,000 because such a polyolefin-based resin allows a polyolefin porous film and a nonaqueous electrolyte secondary battery laminated separator to have a higher strength.

The polyolefin porous film has a film thickness of preferably 3 μm to 20 μm, more preferably 5 μm to 17 μm, and even more preferably 5 μm to 15 μm. The film thickness which is not less than 3 μm makes it possible to satisfactorily achieve a function (such as the shutdown function) which the polyolefin porous film is required to have. The film thickness which is not more than 20 μm makes it possible to achieve a thinner nonaqueous electrolyte secondary battery laminated separator.

The polyolefin porous film has pores each having a pore diameter of preferably not more than 0.1 μm, and more preferably not more than 0.06 μm. This allows the nonaqueous electrolyte secondary battery separator to achieve sufficient ion permeability and to prevent particles, constituting an electrode, from entering the nonaqueous electrolyte secondary battery separator.

The polyolefin porous film typically has a weight per unit area of preferably 4 g/m² to 20 g/m², and more preferably 5 g/m² to 12 g/m², so as to allow a nonaqueous electrolyte secondary battery to have a higher weight energy density and a higher volume energy density.

The polyolefin porous film has an air permeability of preferably 30 sec/100 mL to 500 sec/100 mL, more preferably 50 sec/100 mL to 300 sec/100 mL, in terms of Gurley values. This allows a nonaqueous electrolyte secondary battery laminated separator to have sufficient ion permeability.

The polyolefin porous film has a porosity of preferably 20% by volume to 80% by volume, more preferably 30% by volume to 75% by volume. This makes it possible to (i) retain a larger amount of electrolyte and (ii) reliably prevent (shut down) a flow of an excessively large electric current at a lower temperature.

A method of producing the polyolefin porous film is not limited in particular, and any publicly known method can be employed. For example, as disclosed in Japanese Patent No. 5476844, a method can be employed in which (i) a filler is added to a thermoplastic resin, (ii) the thermoplastic resin to which the filler is added is formed into a film, and then (iii) the filler is removed.

A specific example is a method for producing a polyolefin porous film from a polyolefin-based resin containing an ultra-high molecular weight polyethylene and a low molecular weight polyolefin having a weight-average molecular weight of not more than 10,000. In this case, it is preferable in terms of production cost to produce a polyolefin porous film by the method including the following steps (1) to (4) of:

(1) kneading 100 parts by weight of an ultra-high molecular weight polyethylene, 5 parts by weight to 200 parts by weight of a low molecular weight polyolefin having a weight-average molecular weight of not more than 10,000, and 100 parts by weight to 400 parts by weight of an inorganic filler such as calcium carbonate, so that a polyolefin-based resin composition is obtained;

(2) shaping the polyolefin-based resin composition into a sheet;

(3) removing the inorganic filler from the sheet produced in the step (2); and

(4) stretching the sheet produced in the step (3). Alternatively, the polyolefin porous film can be produced by a method disclosed in any of the foregoing Patent Literatures.

Alternatively, the polyolefin porous film can be a commercially available product having the above-described characteristics.

(Porous Layer)

The porous layer typically contains a filler and a binder resin.

Examples of a type of filler include an organic filler and an inorganic filler.

Examples of the organic filler include fillers made of (i) a homopolymer of a monomer such as styrene, vinyl ketone, acrylonitrile, methyl methacrylate, ethyl methacrylate, glycidyl methacrylate, glycidyl acrylate, or methyl acrylate, or (ii) a copolymer of two or more of such monomers; a fluorine-based resin such as polytetrafluoroethylene, an ethylene tetrafluoride-propylene hexafluoride copolymer, an ethylene tetrafluoride-ethylene copolymer, or polyvinylidene fluoride; a melamine resin; an urea resin; polyolefin; or polymethacrylate. These organic fillers each can be used solely, or a mixture of two or more thereof can be alternatively used. Among these organic fillers, polytetrafluoroethylene powder is preferable due to its chemical stability.

Examples of the inorganic filler include materials made of an inorganic matter such as a metal oxide, a metal nitride, a metal carbide, a metal hydroxide, a carbonate, or a sulfate. Specific examples of the inorganic filler include alumina powder, boehmite powder, silica powder, titanium dioxide powder, aluminum hydroxide powder, and calcium carbonate powder. These inorganic fillers each can be used solely, or a mixture of two or more thereof can be alternatively used. Among these inorganic fillers, alumina powder is preferable due to its chemical stability.

Examples of the shape of the filler include a substantially spherical shape, a plate shape, a columnar shape, a needle shape, a whisker shape, and a fibrous shape. These shapes can be applied to any particles. Substantially spherical particles, which make it easy to form uniform pores, are preferable.

The filler content in the porous layer is preferably 20% by weight to 95% by weight, more preferably 30% by weight to 90% by weight, and even more preferably 40% by weight to 90% by weight. Note that the filler content in the porous layer is calculated assuming that the total weight of the porous layer is 100% by weight. The filler content which is set within the above range makes it possible to achieve a separator which has a good ion permeability.

The filler contained in the porous layer has an average particle diameter of preferably 0.01 μm to 2.0 μm, and more preferably 0.05 μm to 1.0 μm. When the average particle diameter of the filler is set within the above range, the “average particle diameter of the filler” herein means a volume-based average particle diameter (D50) of the filler. D50 means a particle diameter having a value at which a cumulative value of 50% is reached in a volume-based particle size distribution. D50 can be measured with use of, for example, a laser diffraction particle size analyzer (product name: SALD2200, etc. manufactured by Shimadzu Corporation).

The binder resin is preferably a resin which is insoluble in the electrolyte of the battery and which is electrochemically stable when the battery is in normal use.

Examples of the binder resin include polyolefins; (meth)acrylate-based resins; fluorine-containing resins; polyamide-based resins; polyimide-based resins; polyamideimide-based resins; polyester-based resins; rubbers; resins each having a melting point or a glass transition temperature of not less than 180° C.; water-soluble polymers; and polycarbonate, polyacetal, and polyether ether ketone.

Among the above-described resins, (meth)acrylate-based resins, fluorine-containing resins, polyamide-based resins, polyimide-based resins, polyamideimide-based resins, polyester-based resins, and water-soluble polymers are preferable.

Preferable examples of the polyolefins include polyethylene, polypropylene, polybutene, and an ethylene-propylene copolymer.

Examples of the fluorine-containing resins include polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkylvinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. The fluorine-containing resins listed above are particularly exemplified by a fluorine-containing rubber having a glass transition temperature of not more than 23° C.

Preferable examples of the polyamide-based resins include aramid resins such as aromatic polyamides and wholly aromatic polyamides.

Specific examples of the aramid resins include poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Among the above aramid resins, poly(paraphenylene terephthalamide) is more preferable.

The polyester-based resins are preferably aromatic polyesters such as polyarylates, and liquid crystal polyesters.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins each having a melting point or a glass transition temperature of not less than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

Note that the binder resins can be used in one kind or in combination of two or more kinds.

(Adhesion Layer)

The adhesion layer makes adhesion between the nonaqueous electrolyte secondary battery laminated separator and the electrode plate (the positive electrode plate or the negative electrode plate). The adhesion layer contains an adhesive resin as a main component. Examples of the adhesive resin include an α-olefin copolymer and other adhesive resins.

The “α-olefin copolymer” herein refers to a copolymer having a structural unit derived from α-olefin and a structural unit derived from another monomer.

The α-olefin is preferably α-olefin having 2 to 8 carbon atoms. Examples of such an α-olefin include ethylene, propylene, 1-butene, 1-pentene, 1-hexene, 1-heptene, and 1-octene. Among the above-described α-olefins, ethylene is preferable. The α-olefin-derived structural unit of the α-olefin copolymer may be only one type of structural unit or may be two or more types of structural units.

The another monomer is not particularly limited as long as it is a monomer copolymerizable with α-olefin. Examples of the another monomer include fatty acid vinyls (such as vinyl acetate, vinyl propionate, vinyl butyrate, vinyl laurate, vinyl caproate, vinyl stearate, vinyl palmitate, and vinyl versatate); acrylic acid esters each having a C1-C16 alkyl group (such as methyl acrylate, ethyl acrylate, propyl acrylate, butyl acrylate, hexyl acrylate, octyl acrylate, and lauryl acrylate); methacrylic acid esters each having a C1-C16 alkyl group (such as ethyl methacrylate, propyl methacrylate, butyl methacrylate, hexyl methacrylate, octyl methacrylate, and lauryl methacrylate); acidic group-containing vinyl monomers (such as acrylic acid, methacrylic acid, 2-acryloyloxyethyl succinate, 2-methacryloyloxyethyl succinate, carboxy ethyl acrylate, and carboxy ethyl methacrylate); aromatic vinyl monomers (such as styrene, benzyl acrylate, and benzyl methacrylate); dienes (1,3-butadiene and isoprene); and acrylonitriles. Among the above-mentioned monomers, fatty acid vinyls, acrylic acid esters, and methacrylic acid esters are preferable, and vinyl acetate and ethyl acrylate are more preferable. The structural unit derived from another monomer in the α-ethylene copolymer may be only one type of structural unit or may be two or more types of structural units.

A preferable α-olefin copolymer has (i) a structural unit derived from α-olefin and (ii) a structural unit derived from one or more substances selected from the group consisting of fatty acid vinyls, acrylic acid esters, and methacrylic acid esters. A more preferable α-olefin copolymer has (i) a structural unit derived from α-olefin and (ii) a structural unit derived from one or more substances selected from the group consisting of vinyl acetate and ethyl acrylate.

Examples of adhesive resins other than the α-olefin copolymers include fluoropolymers (such as polyvinylidene fluoride); ester polymers (such as polyethylene terephthalate and polybutylene terephthalate); cellulosic polymers (such as carboxymethyl cellulose, carboxyethyl cellulose, ethyl cellulose, hydroxymethyl cellulose, hydroxypropyl cellulose, and carboxyethyl methyl cellulose).

The thickness of the adhesion layer is preferably 0.005 μm to 100 μm, more preferably 0.005 μm to 20 μm, and even more preferably 0.005 μm to 10 μm. The adhesion layer having the thickness which falls within the above range will not significantly increase internal resistance when the adhesion layer is used as a member of a nonaqueous electrolyte secondary battery.

The weight per unit area of the adhesion layer is preferably 0.0005 g/m² to 10 g/m², more preferably 0.0005 g/m² to 2.0 g/m², and even more preferably 0.0005 g/m² to 0.25 g/m².

The proportion of the adhesive resin in the adhesion layer is preferably not less than 50% by weight, more preferably not less than 70% by weight, even more preferably not less than 90% by weight, assuming that the weight of the entire adhesion layer is 100% by weight. In an embodiment, the adhesion layer is substantially made of only the adhesive resin. When the content of the adhesive resin in the adhesion layer falls within the above range, sufficient adhesive strength is attained.

The weight per unit area of the adhesive resin in the adhesion layer is preferably 0.001 g/m² to 1 g/m², more preferably 0.01 g/m² to 1 g/m², and even more preferably 0.05 g/m² to 0.5 g/m². When the weight per unit area of the adhesive resin is not less than 0.001 g/m², sufficient adhesive strength is attained. When the weight per unit area of the adhesive resin is not more than 1 g/m², internal resistance will not be significantly increased when the adhesion layer is used as a member of a nonaqueous electrolyte secondary battery.

(Porous Layer Having Adhesiveness)

The porous layer itself contained in the nonaqueous electrolyte secondary battery laminated separator can be configured so as to have adhesiveness. For example, by causing an adhesive resin to be contained in the porous layer, it is possible to form a porous layer having adhesiveness.

Examples of the adhesive resin which can be contained in the porous layer include the adhesive resin mentioned under the section of (Adhesive layer). For descriptions of other resins and fillers contained in the porous layer, the description under the section of (Porous layer) is incorporated.

[Positive Electrode]

Examples of the positive electrode encompass a positive electrode sheet having a structure in which an active material layer containing a positive electrode active material and a binding agent is formed on a current collector. The active material layer can further contain an electrically conductive agent.

Examples of the positive electrode active material include a material capable of being doped and dedoped with lithium ions. Examples of such a material include a lithium complex oxide containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and a fired product of an organic polymer compound.

Examples of the binding agent include thermoplastic resins such as polyvinylidene fluoride, a copolymer of vinylidene fluoride, polytetrafluoroethylene, a copolymer of vinylidene fluoride-hexafluoropropylene, a copolymer of tetrafluoroethylene-hexafluoropropylene, a copolymer of tetrafluoroethylene-perfluoroalkyl vinyl ether, a copolymer of ethylene-tetrafluoroethylene, a copolymer of vinylidene fluoride-tetrafluoroethylene, a copolymer of vinylidene fluoride-trifluoroethylene, a copolymer of vinylidene fluoride-trichloroethylene, a copolymer of vinylidene fluoride-vinyl fluoride, a copolymer of vinylidene fluoride-hexafluoropropylene-tetrafluoroethylene, a thermoplastic polyimide, polyethylene, and polypropylene; acrylic resins; and styrene-butadiene rubber. Note that the binding agent serves also as a thickener.

Examples of the positive electrode current collector include electric conductors such as Al, Ni, and stainless steel. Among these, Al is preferable because Al is easily processed into a thin film and is inexpensive.

The positive electrode which is in a sheet form can be produced by, for example, a method of applying a pressure to the positive electrode active material, the electrically conductive agent, and the binding agent active material on the positive electrode current collector to form a positive electrode mix thereon; or a method of (i) using an appropriate organic solvent to make the positive electrode active material, the electrically conductive material, and the binding agent in a paste form so as to provide a positive electrode mix, (ii) applying the positive electrode mix to the positive electrode current collector, (iii) drying the applied positive electrode mix to prepare a sheet-like positive electrode mix, and (iv) applying a pressure to the sheet-like positive electrode mix so that the sheet-like positive electrode mix is firmly fixed to the positive electrode current collector.

[Negative Electrode]

Examples of the negative electrode include a negative electrode sheet having a structure in which an active material layer containing a negative electrode active material and a binding agent is formed on a current collector. The active material layer can further contain an electrically conductive agent.

Examples of the negative electrode active material include (i) a material capable of being doped and dedoped with lithium ions, (ii) a lithium metal, and (iii) a lithium alloy. Examples of the material include carbonaceous materials such as natural graphite, artificial graphite, cokes, carbon black, pyrolytic carbons, carbon fiber, and a fired product of an organic polymer compound; chalcogen compounds such as an oxide and a sulfide which are doped and dedoped with lithium ions at an electric potential lower than that of the positive electrode; metals such as aluminum (Al), lead (Pb), tin (Sn), bismuth (Bi), and silicon (Si), each of which is alloyed with alkali metal; an intermetallic compound (AlSb, Mg₂Si, NiSi₂) of a cubic system in which intermetallic compound alkali metal can be inserted in a space in a lattice; and a lithium nitrogen compound (Li₃₋ₓMₓN (where M represents a transition metal)).

Examples of the negative electrode current collector include Cu, Ni, and stainless steel. Among these, Cu is preferable because Cu is not easily alloyed with lithium particularly in the case of a lithium ion secondary battery and is easily processed into a thin film.

The negative electrode which is in a sheet form can be produced by, for example, a method of applying a pressure to the negative electrode active material on the negative electrode current collector to form a negative electrode mix thereon; or a method of (i) using an appropriate organic solvent to make the negative electrode active material in a paste form so as to provide a negative electrode mix, (ii) applying the negative electrode mix to the negative electrode current collector, (iii) drying the applied negative electrode mix to prepare a sheet-like negative electrode mix, and (iv) applying a pressure to the sheet-like negative electrode mix so that the sheet-like negative electrode mix is firmly fixed to the negative electrode current collector. The paste preferably includes the electrically conductive agent and the binding agent.

[5. Nonaqueous Electrolyte Secondary Battery]

The nonaqueous electrolyte secondary battery in accordance with an embodiment of the present invention includes the nonaqueous electrolyte secondary battery member in accordance with an embodiment of the present invention. The nonaqueous electrolyte secondary battery can be produced by, for example, the following procedure.

1. The nonaqueous electrolyte secondary battery member is stored in an appropriate container.
2. The container is filled with a nonaqueous electrolyte.
3. The container is hermetically sealed under reduced pressure.

[Nonaqueous Electrolyte]

The nonaqueous electrolyte can be, for example, a nonaqueous electrolyte containing an organic solvent and a lithium salt dissolved in the organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is preferable to use, among the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Examples of the organic solvent include carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxycarbonyloxy)ethane; ethers such as 1,2-dimethoxyethane, 1,3-dimethoxypropane, pentafluoropropyl methylether, 2,2,3,3-tetrafluoropropyl difluoromethylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents prepared by introducing a fluorine group into the organic solvents listed above. Among the above organic solvents, carbonates are preferable. A mixed solvent of a cyclic carbonate and an acyclic carbonate or a mixed solvent of a cyclic carbonate and an ether is further preferable. The mixed solvent of a cyclic carbonate and an acyclic carbonate is further preferably a mixed solvent of ethylene carbonate, dimethyl carbonate, and ethyl methyl carbonate. Such a mixed solvent allows a wider operating temperature range, and is not easily decomposed even in a case where the negative electrode active material is a graphite material such as natural graphite or artificial graphite.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss embodiments of the present invention in further detail with reference to Examples and Comparative Examples. Note, however, that the present invention is not limited to those Examples.

[Materials Used]

In the Examples, Peeling Test A and Peeling Test B were carried out using the following materials.
Positive electrode plate: A positive electrode plate (5 cm long×2 cm wide×1 mm thick) in which an electrode active material consisting of lithium nickel cobalt manganese oxide (NCM523), carbon black, graphite, and PVDF in a ratio of 92:2.5:2.5:3 was formed on an aluminum foil
Negative electrode plate: A negative electrode plate (5 cm long×2 cm wide×1 mm thick) in which an electrode active material consisting of graphite, SBR, and CMC in a ratio of 98:1:1 was formed on a copper foil
Laminated separator: A laminated separator (10 cm long×2.5 cm wide) in which a porous layer was formed on one surface of a polyethylene porous film, wherein the composition of the porous layer was such that aramid resin:alumina=33:67
Adhesive resin: Ethylene-vinyl acetate copolymer (EVA) or polyvinylidene fluoride (PVDF)
Electrolyte: Ethylene carbonate:dimethyl carbonate:ethyl methyl carbonate=30:35:35 (volume ratio).

As described above, in the Examples, the laminated separator has a larger dimension than the positive electrode plate and the negative electrode plate. In carrying out the peeling test, the laminated separator was peeled off by grasping a portion of the laminated separator which portion was not adhered to the electrode plate.

[Measurement Method and Testing Method]

[Peeling Test A: Peeling Test in an Electrolyte Immersion State]

Peeling Test A was carried out by the following procedure.

1. A prepared nonaqueous electrolyte secondary battery laminated body was immersed in an electrolyte at 60° C. for 24 hours.
2. A first electrode plate of the nonaqueous electrolyte secondary battery laminated body was fixed to a substrate (glass epoxy plate measuring 10 cm long×3 cm wide×1 mm thick). A double-sided tape was used for fixing.
3. A nonaqueous electrolyte secondary battery laminated separator was peeled off at a peeling speed of 100 mm/min in an atmosphere of 23° C. so that the angle between the first electrode plate and the nonaqueous electrolyte secondary battery laminated separator was 180°. RTG-1310 (manufactured by Orientec) was used for peeling. At this time, the peel strength was also measured.

[Peeling Test B: Peeling Test in a Dry State]

Peeling Test B was carried out by the following procedure.

1. A nonaqueous electrolyte secondary battery laminated body which was not immersed in an electrolyte was prepared.
2. A first electrode plate of the nonaqueous electrolyte secondary battery laminated body was fixed to a substrate (glass epoxy plate measuring 10 cm long×3 cm wide×1 mm thick). Double-sided tape was used for fixing.
3. A nonaqueous electrolyte secondary battery laminated separator was peeled off at a peeling speed of 100 mm/min in an atmosphere of 23° C. so that the angle between the first electrode plate and the nonaqueous electrolyte secondary battery laminated separator was 180°. RTG-1310 (manufactured by Orientec) was used for peeling. At this time, the peel strength was also measured.

[Observation to Determine Whether or not Peeling had Occurred]

The first electrode plate after the Peeling Test A or B was visually observed to determine whether or not peeling of the porous layer had occurred.

[Weight Per Unit Area of Adhesion Layer (EVA)]

For the nonaqueous electrolyte secondary battery laminated body using EVA as the adhesive resin, the infrared absorption strength ratio (IR intensity ratio) was calculated and regarded as a parameter representing the weight per unit area of the adhesion layer. Specifically, the infrared absorption strength ratio was calculated by dividing the IR intensity (1740 cm⁻¹) peculiar to EVA by the IR intensity (1470 cm⁻¹) peculiar to polyethylene. The higher the IR intensity ratio is, the higher the weight per unit area of the EVA is.

### Examples 1 to 5 and Comparative Examples 1 to 3

Table 1 shows the results of Peeling Test A and Peeling Test B of the nonaqueous electrolyte secondary battery laminated bodies in accordance with Examples 1 to 5 and Comparative Examples 1 to 3. The types of adhesive resins, weights per unit area of the adhesion layers, and a pressing condition at the preparation of the nonaqueous electrolyte secondary battery laminated bodies are as shown in Table 1.

TABLE 1

| | | | | First electrode plate = | | | | First electrode plate = | | | |
|---|---|---|---|---|---|---|---|---|---|---|---|
| | | | | Positive electrode plate | | | | Negative electrode plate | | | |
| | | Weight per | | Peeling Test A | | Peeling Test B | | Peeling Test A | | Peeling Test B | |
| | | unit area of | | | Whether | | Whether | | Whether | | Whether |
| | | EVA | Press | Peel | or not | Peel | or not | Peel | or not | Peel | or not |
| | Adhesive | (IR intensity | Condition | strength | peeling | strength | peeling | strength | peeling | strength | peeling |
| | resin | ratio) | (° C., MPa, s) | (N/m) | occurred | (N/m) | occurred | (N/m) | occurred | (N/m) | occurred |
| Example 1 | EVA | 0.102 | 70, 6, 10 | 1.2 | Not | 2.2 | Not | 1.8 | Not | 13.8 | Occurred |
| | | | | | occurred | | occurred | | occurred | | |
| Example 2 | PVDF | — | 70, 6, 10 | 1.6 | Not | 7.0 | Not | 1.9 | Not | 11.9 | Occurred |
| | | | | | occurred | | occurred | | occurred | | |
| Example 3 | EVA | 0.189 | 70, 6, 10 | 1.9 | Not | 9.9 | Occurred | 10.1 | Occurred | | |
| | | | | | occurred | | | | | | |
| Example 4 | EVA | 0.235 | 70, 6, 10 | 4.9 | Not | | | 10.1 | Occurred | | |
| | | | | | occurred | | | | | | |
| Example 5 | EVA | 0.303 | 70, 2, 10 | 5.9 | Not | | | 8.6 | Occurred | | |
| | | | | | occurred | | | | | | |
| Comparative | EVA | 0.270 | 70, 6, 10 | 8.3 | Occurred | | | 15.2 | Occurred | | |
| Example 1 | | | | | | | | | | | |
| Comparative | EVA | 0.303 | 70, 4, 10 | 11.6 | Occurred | | | 13.6 | Occurred | | |
| Example 2 | | | | | | | | | | | |
| Comparative | EVA | 0.303 | 70, 6, 10 | 11.2 | Occurred | 23.2 | Occurred | | | | |
| Example 3 | | | | | | | | | | | |

### Reference Example 1

The nonaqueous electrolyte secondary battery laminated separator used in Examples and Comparative Examples was immersed in the electrolyte at 60° C. for 24 hours in the same manner as in Peeling Test A. Next, the peel strength between the polyethylene porous film and the porous layer was measured in accordance with the method specified in JIS-K-6854-2 (Adhesives-Determination of peel strength of bonded assemblies-Part 2: 180° peel). The peel strength was found to be 8.1 N/m.

### Reference Example 2

The nonaqueous electrolyte secondary battery laminated separator used in Examples and Comparative

Examples was prepared in a dry state. Next, the peel strength between the polyethylene porous film and the porous layer was measured in accordance with the method specified in JIS-K-6854-2 (Adhesives-Determination of peel strength of bonded assemblies-Part 2: 180° peel). The peel strength was found to be 8.0 N/m.

[Results]

By adjusting the type of adhesive resin, the weight per unit area of the adhesion layer, and the pressing conditions as in Examples 1 to 5, the nonaqueous electrolyte secondary battery laminated bodies having an adequate adhesiveness between the electrode plate and the separator were produced. Comparison of Examples 1, 3, and 4 with Comparative Examples 1 and 3 shows that a nonaqueous electrolyte secondary battery laminated body having a higher weight per unit area of the adhesion layer tends to have higher adhesiveness between the electrode plate and the separator. Comparison of Example 5 with Comparative Examples 2 and 3 shows that a higher press pressure tends to bring about a nonaqueous electrolyte secondary battery laminated body having higher adhesiveness between the electrode plate and the separator.

The nonaqueous electrolyte secondary battery laminated bodies in accordance with Embodiments 1 and 2, when having a positive electrode plate as the first electrode plate, were free from peeling of the porous layer and had optimal adhesiveness, regardless of whether the nonaqueous electrolyte secondary battery laminated bodies were in the state of being immersed in the electrolyte or in the dry state. These nonaqueous electrolyte secondary battery laminated bodies, even when having a negative electrode plate as the first electrode plate, were free from peeling of the porous layer in the state of being immersed in the electrolyte and thus were preferable.

The results of Examples 1 to 5 and Reference Example suggest that the peel strength in Peeling Test A is preferably about not more than 8 N/m. The results of Examples 1 and 2 and Reference Example 2 suggest that the peel strength in Peeling Test B is preferably about not more than 8 N/m.

### INDUSTRIAL APPLICABILITY

The present invention can be used in, for example, a nonaqueous electrolyte secondary battery.

### REFERENCE SIGNS LIST

10: first electrode plate
20: adhesion layer
30: porous layer
40: polyolefin porous film
50: second electrode plate
100a, 100b: nonaqueous electrolyte secondary battery laminated separator
200a, 200b: nonaqueous electrolyte secondary battery laminated body
500: nonaqueous electrolyte secondary battery member

1. A nonaqueous electrolyte secondary battery laminated body in which a first electrode plate and a nonaqueous electrolyte secondary battery laminated separator are laminated,
the nonaqueous electrolyte secondary battery laminated separator comprising: a polyolefin porous film; and a porous layer which is formed on one surface or both surfaces of the polyolefin porous film,
wherein the nonaqueous electrolyte secondary battery laminated separator has an outermost surface layer which is in contact with the first electrode plate and which has adhesiveness with respect to the first electrode plate,
a peel strength between the first electrode plate and the outermost surface layer of the nonaqueous electrolyte secondary battery laminated separator is lower than a peel strength between the porous layer and the polyolefin porous film, when said nonaqueous electrolyte secondary battery laminated body has been subjected to Peeling Test A under the following conditions:
Step 1A. Said nonaqueous electrolyte secondary battery laminated body is immersed, at 60° C. for 24 hours, in a solvent of ethylene carbonate, dimethyl carbonate, ethyl methyl carbonate in a volume ratio of 30:35:35;
Step 2A. The first electrode plate is fixed on a substrate; and
Step 3A. The nonaqueous electrolyte secondary battery laminated separator is peeled off at a peeling speed of 100 mm/min so that an angle between the first electrode plate and the nonaqueous electrolyte secondary battery laminated separator is 180°.

2. The nonaqueous electrolyte secondary battery laminated body according to claim 1, wherein the peel strength in the Step 3A is not more than 8 N/m.

3. The nonaqueous electrolyte secondary battery laminated body according to claim 1, wherein the peel strength between the first electrode plate and the outermost surface layer of the nonaqueous electrolyte secondary battery laminated separator is lower than the peel strength between the porous layer and the polyolefin porous film, when said nonaqueous electrolyte secondary battery laminated body has been subjected to Peeling Test B under the following conditions:
Step 1B. The nonaqueous electrolyte secondary battery laminated body is dried so that a content of the solvent is not more than 2% by weight;
Step 2B. The first electrode plate is fixed on the substrate; and
Step 3B. The nonaqueous electrolyte secondary battery laminated separator is peeled off at a peeling speed of 100 mm/min so that an angle between the first electrode plate and the nonaqueous electrolyte secondary battery laminated separator is 180°.

4. The nonaqueous electrolyte secondary battery laminated body according to claim 3, wherein the first electrode plate is a positive electrode plate, and
the peel strength in the Step 3B is not more than 8 N/m.

5. The nonaqueous electrolyte secondary battery laminated body according to claim 1, wherein the porous layer contains one or more resins selected from the group consisting of (meth)acrylate-based resins, fluorine-containing resins, polyamide-based resins, polyimide-based resins, polyamideimide-based resins, polyester-based resins, and water-soluble polymers.

6. The nonaqueous electrolyte secondary battery laminated body according to claim 1, wherein the porous layer contains an aramid resin.

7. A nonaqueous electrolyte secondary battery member comprising: a nonaqueous electrolyte secondary battery laminated body according to claim 1; and a second electrode plate,
wherein, in said nonaqueous electrolyte secondary battery member, the first electrode plate, the nonaqueous electrolyte secondary battery laminated separator, and the second electrode plate are disposed in this order.

8. The nonaqueous electrolyte secondary battery member according to claim 7, wherein one of the first electrode plate and the second electrode plate is a positive electrode plate, and the other is a negative electrode plate,
the peel strength between the positive electrode plate and the nonaqueous electrolyte secondary battery laminated separator is lower than the peel strength between the negative electrode plate and the nonaqueous electrolyte secondary battery laminated separator.

9. A nonaqueous electrolyte secondary battery comprising a nonaqueous electrolyte secondary battery laminated body according to claim 1.

10. A nonaqueous electrolyte secondary battery laminated separator comprising: a polyolefin porous film; and a porous layer which is formed one surface or both surfaces of the polyolefin porous film,
wherein at least one of outermost surface layers of the nonaqueous electrolyte secondary battery laminated separator lies on a side of the porous layer and has adhesiveness with respect to a test electrode plate,
the test electrode plate is a 1-mm-thick laminated body in which an electrode active material consisting of lithium nickel cobalt manganese oxide (NCM523), carbon black, graphite, and PVDF in a ratio of 92:2.5:2.5:3 is formed on an aluminum foil,
a peel strength between the test electrode plate and the outermost surface layer of the nonaqueous electrolyte secondary battery laminated separator is lower than a peel strength between the porous layer and the polyolefin porous film, when said nonaqueous electrolyte secondary battery laminated body has been subjected to Peeling Test C under the following conditions:
Step 1C. The nonaqueous electrolyte secondary battery laminated separator and the test electrode plate are laminated such that the porous layer and the test electrode plate face each other via the outermost surface layer having adhesiveness with respect to the test electrode plate, and pressing is performed under the conditions of 70° C., 6 MPa, and 10 seconds to prepare a test laminated body;
Step 2C. The test laminated body is immersed, at 60° C. for 24 hours, in a solvent of ethylene carbonate, dimethyl carbonate, ethyl methyl carbonate in a volume ratio of 30:35:35;
Step 3C. The test electrode plate is fixed on a substrate; and
Step 4C. The nonaqueous electrolyte secondary battery laminated separator is peeled off at a peeling speed of 100 mm/min so that an angle between the test electrode plate and the nonaqueous electrolyte secondary battery laminated separator is 180°.

11. A nonaqueous electrolyte secondary battery comprising a nonaqueous electrolyte secondary battery member according to claim 7.
